(19) United States
(12) Patent Application Publication
(10) Pub. No.: US 2020/0130389 A1
(43) Pub. Date: Apr. 30, 2020

(54) IMAGE FORMING APPARATUS

(71) Applicant: TOSHIBA TEC KABUSHIKI KAISHA, Tokyo (JP)

(72) Inventor: Koichiro Sato, Nagaizumi Sunto Shizuoka (JP)

(73) Assignee: TOSHIBA TEC KABUSHIKI KAISHA, Tokyo (JP)

(21) Appl. No.: 16/170,525

(22) Filed: Oct. 25, 2018

(51) Int. Cl. B41J 29/38; B41F 19/02; B41F 33/00

(52) U.S. Cl. CPC B41J 29/38; H04N 1/00411; B41F 33/0036; B41F 19/02

(57) ABSTRACT

An image forming apparatus includes a printing section and an unleveling section. The printing section forms an image on a sheet-like medium based on image data indicating a color component corresponding to a coordinate indicating a position on the medium. The unleveling section has a protrusion capable of abutting against the medium, and forms at least either a convex portion or a concave portion on the medium by enabling the protrusion to abut against or move away from the medium on which the printing section forms an image, the convex or concave portion formed based on height data indicating a height of each coordinate indicating the position on the medium.

### FIELD

Embodiments described herein relate generally to an image forming apparatus.

### BACKGROUND

There is known a technology for forming unevenness on a sheet, such as an embossment. However, such a processing technology takes much time and cost due to necessity of a mold or the like.

### DESCRIPTION OF THE DRAWINGS

FIG. 1 is a diagram schematically illustrating an example of an image forming apparatus according to at least one embodiment;

FIG. 2 is a diagram schematically illustrating an example of the image forming apparatus according to at least one embodiment;

FIG. 3 is a perspective view illustrating an example of a processing apparatus according to at least one embodiment;

FIG. 4 is a diagram illustrating an example of a shape of a pin according to at least one embodiment;

FIG. 5 is a perspective view illustrating an example of the processing apparatus according to at least one embodiment;

FIG. 6 is a diagram illustrating a state in which the pin hits an image forming medium according to at least one embodiment;

FIG. 7 is a block diagram illustrating an example of a circuit configuration of main portions of the image forming apparatus according to at least one embodiment;

FIG. 8 is a flowchart depicting an example of a processing by a processor in FIG. 7 according to at least one embodiment;

FIG. 9 is a flowchart depicting an example of the processing by the processor in FIG. 7 according to at least one embodiment;

FIG. 10 is a flowchart depicting an example of a processing by the processor in FIG. 7 according to at least one embodiment;

FIG. 11 is a two-side view illustrating an example of a three-dimensional object;

FIG. 12 is a diagram illustrating an example of height data according to at least one embodiment; and

FIG. 13 is a diagram illustrating a method of specifying unevenness of an image.

### DETAILED DESCRIPTION

In accordance with at least one embodiment, an image forming apparatus comprises a printing section and an unleveling section. The printing section forms an image on a sheet-like medium based on image data indicating a color component corresponding to a coordinate indicating a position on the medium. The unleveling section has a protrusion capable of abutting against the medium, and forms at least either concave portions or convex portions on the medium by enabling the protrusion to abut against or move away from the medium on which the printing section forms an image based on height data indicating a height of each coordinate indicating the position on the medium.

Hereinafter, an image forming apparatus according to an embodiment is described with reference to the accompanying drawings. In each figure used for the description of the embodiment below, the scale of each part may be appropriately changed in some cases. For the convenience of description, configurations of some parts may be omitted in each figure used for the description of the embodiment in some cases.

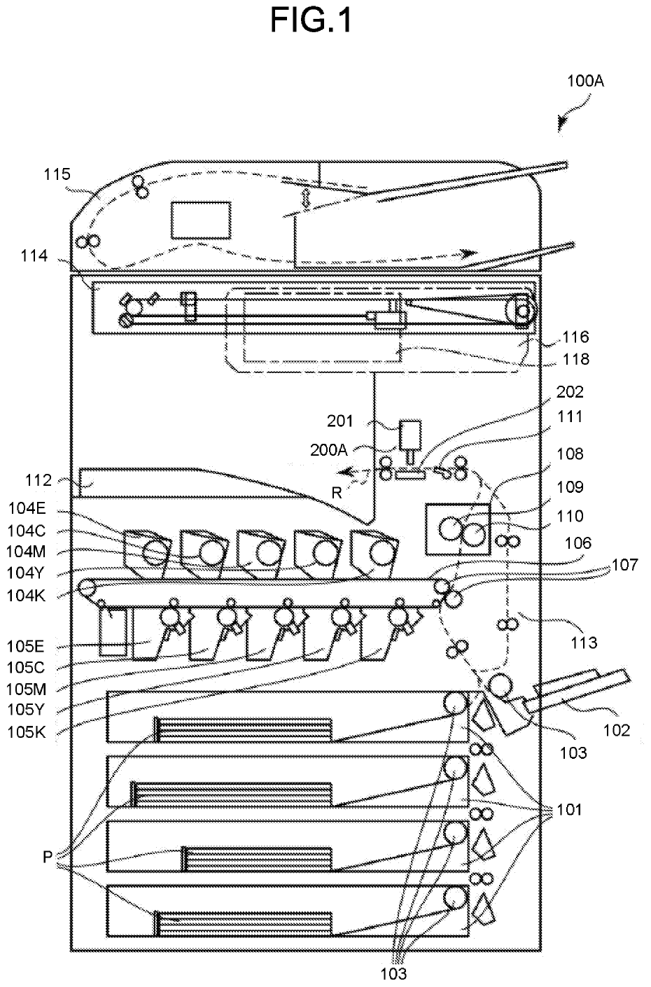

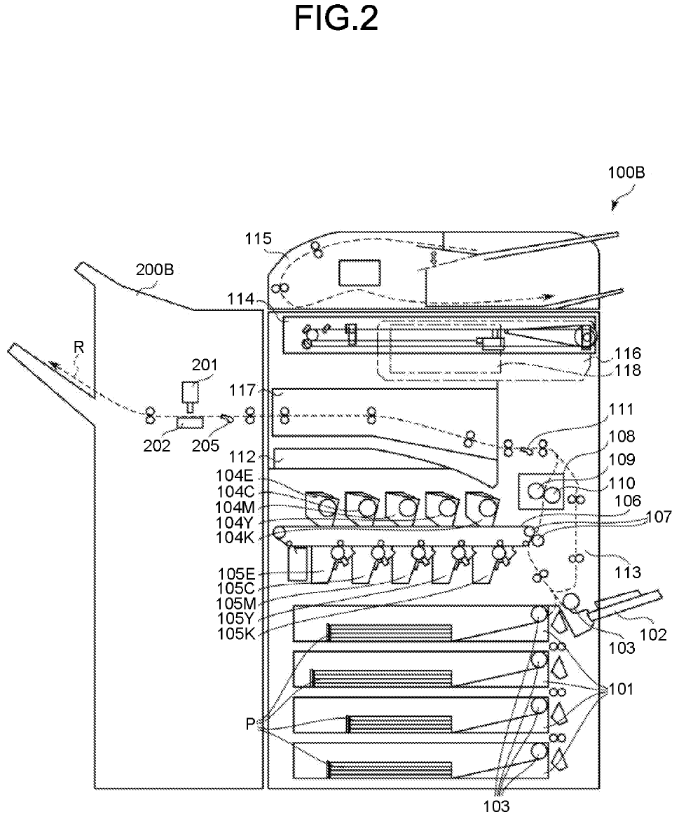

FIG. 1 and FIG. 2 are diagrams each schematically illustrating an example of an image forming apparatus 100 according to at least one embodiment. The image forming apparatus 100 shown in FIG. 1 is referred to as an image forming apparatus 100A, and the image forming apparatus 100 shown in FIG. 2 is referred to as an image forming apparatus 100B. If it is unnecessary to distinguish between the image forming apparatus 100A and the image forming apparatus 100B or if the image forming apparatus 100A and the image forming apparatus 100B are collectively referred to, they are simply referred to as the image forming apparatus 100.

The image forming apparatus 100 is, for example, an MFP (Multifunction Peripheral), a copy machine, a printer, or the like. The image forming apparatus 100 includes, for example, a printing function, an unevenness processing function, an embossed printing function, a scanning function, a copying function, an unevenness copying function, a decoloring function and a facsimile function. The printing function is a function of forming an image using a recording material such as a toner on an image forming medium P. The image forming medium P is, for example, a sheet-like paper. The unevenness processing function is a function of forming unevenness on the medium P by unleveling the image forming medium P. The embossed printing function is a function of forming unevenness using the unevenness processing function on the image forming medium P on which an image is formed by the printing function. The scanning function is a function of reading an image from a document or the like on which the image is formed. The copying function is a function of printing an image read from a document by the scanning function on the image forming medium P using the printing function. The unevenness copying function is a function of reading an image and unevenness from a document or an object and performing embossed printing based on the read data. The decoloring function is a function of decoloring an image formed with a decolorable recording material on the image forming medium P. As an example, the image forming apparatus 100 includes a sheet feed tray 101, a manual feed tray 102, a sheet feed roller 103, a toner cartridge 104, an image forming section 105, a transfer belt 106, a transfer roller 107, a fixing section 108, a heating section 109, a pressure roller 110, a sheet discharge sensor 111, a sheet discharge tray 112, a duplex sheet feed unit 113, a scanning section 114, a document feeder 115, an operation panel 116 and a processing apparatus 200. Incidentally, the image forming apparatus 100B includes a relay unit 117 in addition to those. The processing apparatus 200 shown in FIG. 1 is referred to as a processing apparatus 200A, and the processing apparatus 200 shown in FIG. 2 is referred to as the processing apparatus 200B. If it is unnecessary to distinguish between the processing apparatus 200A and the processing apparatus 200B, or if the processing apparatus 200A and the processing apparatus 200B are collectively referred to, they are simply referred to as the processing apparatus 200. The image forming apparatus 100A includes the processing apparatus 200A therein. The processing apparatus 200B is externally attached to the image forming apparatus 100B. Apart except for the processing apparatus 200B in the image forming apparatus 100B to which the processing apparatus 200B is externally attached is an example of a printing device.

The image forming medium P passes through a route R as an example. The route R is a conveyance path of the image forming medium P.

The sheet feed tray 101 accommodates the image forming medium P used for printing.

The manual feed tray 102 is a table for manually feeding the image forming medium P.

The sheet feed roller 103 is rotated by an operation of a motor to take out the image forming medium P accommodated in the sheet feed tray 101 or the manual feed tray 102 from the sheet feed tray 101 or the manual feed tray 102.

The toner cartridge 104 stores the recording material, such as toner, to be supplied to the image forming section 105. The image forming apparatus 100 comprises one or more toner cartridges 104. As an example, as shown in FIG. 1 and FIG. 2, the image forming apparatus 100 includes five toner cartridges 104, i.e., a toner cartridge 104C, a toner cartridge 104M, a toner cartridge 104Y, a toner cartridge 104K, and a toner cartridge 104E. The toner cartridge 104C, the toner cartridge 104M, the toner cartridge 104Y, and the toner cartridge 104K each store the recording material corresponding to respective colors of CMYK (cyan, magenta, yellow, and key (black)). The toner cartridge 104E stores decolorable recording material. The decolorable recording material is a recording material which is decolored at a temperature higher than a predetermined temperature and becomes invisible. The color and the type of the recording material stored in the toner cartridge 104 are not limited to those described here.

Each image forming section 105 includes a photoconductive drum and a developing device. The developing device develops an electrostatic latent image on the photoconductive drum using the recording material supplied from the corresponding toner cartridge 104. Thus, an image is formed on the photoconductive drum. The image formed on the photoconductive drum is transferred onto the transfer belt 106 (primary transfer).

The image forming apparatus 100 includes one or more image forming sections 105. As an example, as shown in FIG. 1, the image forming apparatus 100 includes five image forming section 105, i.e., an image forming section 105E, an image forming section 105C, an image forming section 105M, an image forming section 105Y and an image forming section 105K. The image forming section 105C, the image forming section 105M, the image forming section 105Y and the image forming section 105K form images using the recording material corresponding to respective colors of CMYK. The image forming section 105E forms an image using the decolorable recording material.

The transfer belt 106 is, for example, an endless belt, and is rotatable by an operation of a roller. The transfer belt 106 rotates to convey the image transferred from each image forming section 105 to a position of the transfer roller 107.

The transfer roller 107 includes two rollers facing each other. The transfer roller 107 transfers the image formed on the transfer belt 106 onto the image forming medium P passing between the rollers of the transfer roller 107 (secondary transfer).

The fixing section 108 heats and pressurizes the image forming medium P onto which the image is transferred. As a result, the image transferred onto the image forming medium P is fixed. The fixing section 108 includes a heating section 109 and a pressure roller 110 facing each other.

The heating section 109 is, for example, a roller provided with a heat source for heating the heating roller 109. The heat source is, for example, a heater. The roller heated by the heat source heats the image forming medium P.

Alternatively, the heating section 109 may include an endless belt suspended on a plurality of rollers. For example, the heating section 109 includes a plate-like heat source, the endless belt, a belt conveyance roller, a tension roller and a press roller. The endless belt is, for example, a film-like member. The belt conveyance roller drives the endless belt. The tension roller applies tension to the endless belt. An elastic layer is formed on the surface of the press roller. The plate-like heat source contacts with the inner side of the endless belt at a heat generating section side thereof and is pressed towards the press roller, thereby forming a fixing nip having a predetermined width between the plate-like heat source and the press roller. Since the plate-like heat source forms a nip area while heating it, the response at the time of energization is higher than that in a case of the heating system using a halogen lamp.

In the endless belt, for example, a silicone rubber layer having a thickness of 200 μm is formed on the outer side of a SUS (Steel Use Stainless) base material having a thickness of 50 μm or polyimide which is a heat resistant resin and has a thickness of 70 μm, and the outermost periphery of the endless belt is coated by a surface protective layer such as PFA (Perfluoroalkoxy Alkane). In the press roller, for example, a silicon sponge layer having a thickness of 5 mm is formed on the surface of a steel bar of φ10, and the outermost periphery of the press roller is coated with a surface protective layer such as PFA.

The plate-like heat source is formed by, for example, laminating a glaze layer and a heat generation resistance layer on a ceramic substrate. The plate-like heat source is bonded with a heat sink made of aluminum to release extra heat to an opposite side thereof and to prevent warping of the substrate. The heat generation resistance layer is made of a known material such as TaSiO₂, for example, and is divided into predetermined length and quantity in a main scanning direction.

The pressure roller 110 pressurizes the image forming medium P passing between the pressure roller 110 and the heating section 109.

The sheet discharge sensor 111 detects that the image forming medium P arrives. As a result, it is possible to detect the position of the image forming medium P on which the printing is terminated.

The sheet discharge tray 112 is a table on which the image forming medium P after printing is discharged.

The duplex sheet feed unit 113 makes the image forming medium P ready for the printing on the back surface thereof. For example, the duplex sheet feed unit 113 reverses front and back surfaces of the image forming medium P by switching back the image forming medium P using rollers or the like. The image forming apparatus 100 may have a mechanism for making the image forming medium P ready for the printing on the back surface thereof using other known methods.

The scanning section 114 reads an image from an object such as a document. The scanning section 114 includes a scanner for reading an image from a document or an object.

The scanner described herein is a scanner of an optical reduction system including an image capturing element, such as a CCD (Charge-Coupled Device) image sensor, for example. Alternatively, the scanner may be a scanner of a contact sensor (CIS (Contact Image Sensor)) system including an image capturing element, such as a CMOS (Complementary Metal-Oxide-Semiconductor) image sensor. The scanner may be a scanner of another known system.

Furthermore, the scanning section 114 may include a distance meter or the like to read a size of unevenness of each coordinate from the object such as the document. The distance meter is, for example, a laser range finder, an optical parallax distance meter, a stereo camera, a radar, or an ultrasonic sensor.

From the above, the scanning section 114 is an example of a reading section (reader) that reads an image and the unevenness from the object.

The document feeder 115 is also called, for example, an ADF (Auto Document Feeder). The document feeder 115 conveys the documents placed on a document tray one after another. An image is read by the scanning section 114 from the conveyed document. The document feeder 115 may include a scanner for reading an image from a back surface of the document. The document feeder 115 includes rollers and motors for conveying the document.

The operation panel 116 includes buttons for an operator of the image forming apparatus 100 to operate and a display device 118. The button functions as an input device for receiving an operation by the operator of the image forming apparatus 100.

The display device 118 is, for example, a touch panel. For example, the touch panel is formed by laminating a display such as a liquid crystal display or an organic EL (Electro-Luminescence) display on a touch pad. The touch panel may be a device capable of detecting the magnitude of a force for touching the panel.

The display device 118 is, for example, a liquid crystal pen tablet. For example, the liquid crystal pen tablet is formed by laminating a display such as a liquid crystal display or an organic EL display on a pen tablet. Alternatively, the operation panel 116 may include a liquid crystal pen tablet attached with the touch panel. The liquid crystal pen tablet attached with the touch panel is, for example, formed by laminating a touch panel on a pen tablet. The liquid crystal pen tablet may be a device capable of detecting a writing pressure for input by a pen.

From the above, the touch pad or the pen tablet of the display device 118 functions as an input device for receiving the operation by the operator of the image forming apparatus 100. The display of the touch panel functions as a display device for notifying the operator of the image forming apparatus 100 of various information.

The relay unit 117 conveys the image forming medium P discharged to the sheet discharge tray 112 to the processing apparatus 200B.

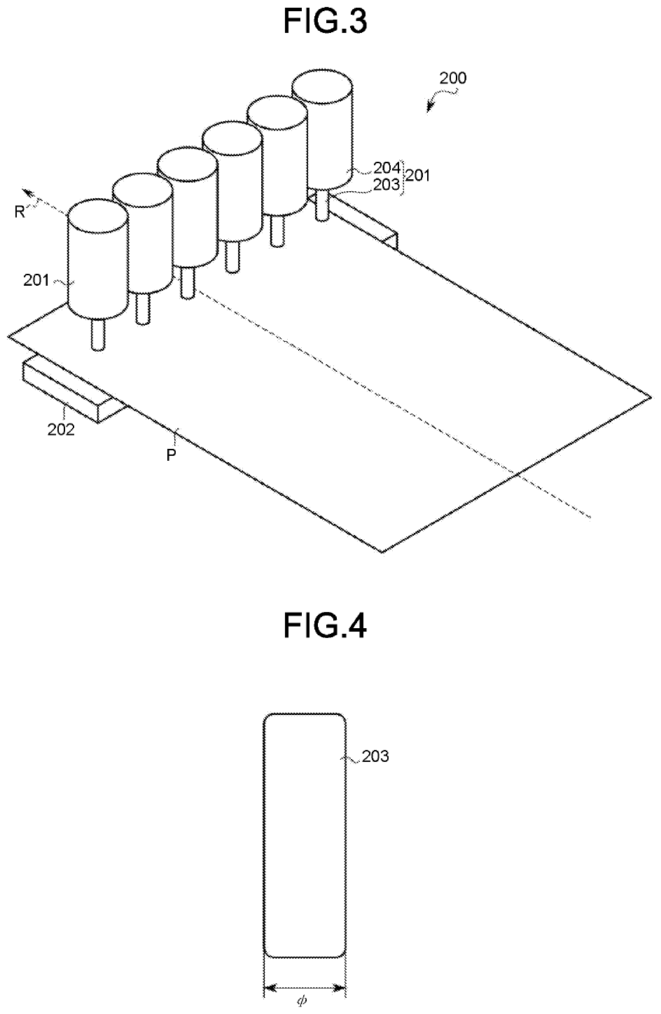

The processing apparatus 200 forms the unevenness on the image forming medium P. The processing apparatus 200A is built into the image forming apparatus 100A. The processing apparatus 200B is externally attached to the image forming apparatus 100B. The processing apparatus 200 is further described with reference to FIG. 3 and FIG. 4. FIG. 3 is a diagram illustrating an example of the processing apparatus 200.

The processing apparatus 200 includes a driving section 201 and an elastic plate 202. The image forming medium P is conveyed to the processing apparatus 200 in such a manner that a printing surface (front surface) thereof is opposite to the driving section 201. In other words, in FIG. 3, a surface that can be seen from this side is the back surface of the image forming medium P, and the printing is performed on the front surface that cannot be seen from this side.

The processing apparatus 200 typically includes a plurality of the driving sections 201. The plurality of the driving sections 201 is arranged in one row, and in FIG. 3, for example, they are arranged in one row and six columns. The number of columns of the driving section 201 is not limited to 6. The plurality of the driving sections 201 is aligned linearly in a row direction (left-right direction). The row direction (left-right direction) is a direction perpendicular to the route R and horizontal to the sheet surface. The row direction (left-right direction) and a column direction are orthogonal to each other. The driving section 201 includes, for example, a pin 203 and an actuator 204.

For example, as shown in FIG. 4, the pin 203 has a shape obtained by performing R chamfering on corners of the cylinder. The shape of the pin 203 is not limited to a cylinder, and may be another column such as an elliptic cylinder or a prism. Alternatively, the shape of the pin 203 may be a frustum, a cone or a cylindrical shape. The pin 203 is not limited to being formed by performing R chamfering, and may be formed by performing another chamfering such as C chamfering. Alternatively, the pin 203 may be formed without performing chamfering. In FIG. 4, a surface of a tip of the pin 203 is flat, but the surface of the tip may have another shape such as a convex curved surface. Alternatively, the tip of the pin 203 may have a pointed shape like a needle. The tip of the pin 203 may have a spherical shape or the like. As described above, the pin 203 is an example of a protrusion.

The actuator 204 is, for example, a solenoid actuator, a motor or a power cylinder. The actuator 204 is preferably a solenoid actuator. The solenoid actuator has advantages such as easy high-speed operation. For example, the actuator 204 performs an operation of extruding the pin 203 and an operation of returning the extruded pin 203. As a result, the actuator 204 raises and lowers the pin 203. The pin 203 extruded by the actuator 204 hits the image forming medium P. In other words, the pin 203 separates from the image forming medium P after abutting against the image forming medium P. The actuator 204 may operate to strike the image forming medium P with the pin 203 or may operate to press the image forming medium P with the pin 203. In the image forming medium P that the pin 203 hits, a portion that the pin 203 hits is recessed. The recessed portion of the image forming medium P protrudes as seen from the surface on opposite side. Therefore, when viewed from the printed surface side, a convex portion is formed in the image forming medium P whose back surface side abuts against the pin 203.

The elastic plate 202 is mainly formed by an elastic body. The elastic plate 202 is, for example, a plate-like rubber. The elastic plate 202 is provided at a position facing the pin 203 across the conveyance path of the image forming medium P. The elastic plate 202 is provided at a position where the pin 203 hits the image forming medium P. Due to the overlap of the image forming medium P and the elastic plate 202, the pin 203 hits the image forming medium P in a state in which the image forming medium P is superimposed on the elastic plate 202. As a result, a portion of the elastic plate 202 that the pin 203 hits is deformed together with the image forming medium P. Therefore, by providing the elastic plate 202, the image forming medium P is easily deformed. By providing the elastic plate 202, it is possible to prevent the image forming medium P from being torn.

By using the driving section 201 as described above, the processing apparatus 200 can perform an unevenness processing on the image forming medium P at two stages of heights including a height when the pin 203 is struck against the image forming medium P and a height when the pin 203 is not struck against the image forming medium P.

The processing apparatus 200B further comprises a position sensor 205. Like the sheet discharge sensor 111, the position sensor 205 detects that the image forming medium P has arrived. In this way, it is possible to detect the position of the image forming medium P after printing.

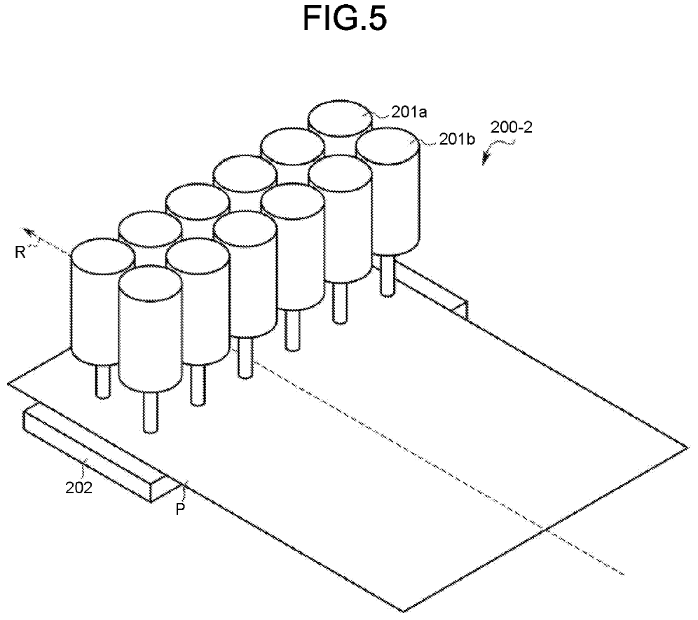

A processing apparatus 200-2 which is a modification of the processing apparatus 200 is described with reference to FIG. 5. The image forming apparatus 100 may include the processing apparatus 200-2 as the processing apparatus 200.

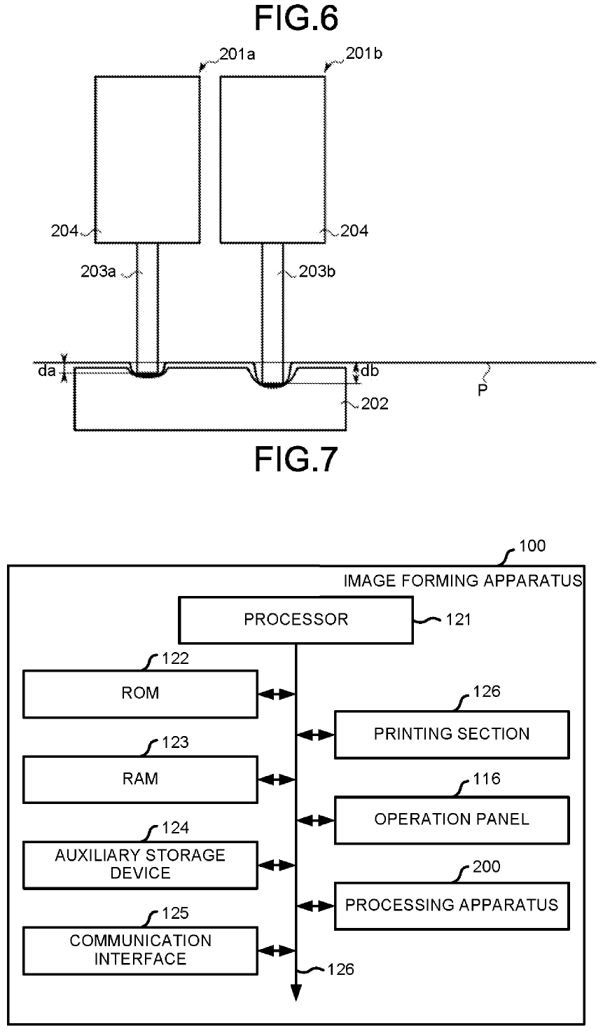

The processing apparatus 200-2 has a plurality of columns of the driving sections 201 provided side by side. As an example, in FIG. 5, the processing apparatus 200-2 has a total of two rows of the driving sections, one row of driving sections 201a and one row of driving sections 201b. In other words, in the processing apparatus 200-2 shown in FIG. 5, the driving sections 201 are arranged in two rows and six columns. The processing apparatus 200-2 may have three or more rows of the driving sections 201. In the processing apparatus 200-2, the number of the driving sections 201 is not limited to six columns. At least one of the stroke of the pin 203 and the length of the pin 203 is different between the driving section 201a and the driving section 201b. Thus, a depth at which the pin 203 hits the image forming medium P is different between the driving section 201a and the driving section 201b. As an example, the depth formed with the driving section 201b is deeper than that formed with the driving section 201a. The depth at which the pin 203 hits the image forming medium P is described with reference to FIG. 6. FIG. 6 is a diagram illustrating a state in which the pin 203 hits the image forming medium P. As shown in FIG. 6, a pin 203a of the driving section 201a extends to a position of a depth da of the image forming medium P. On the other hand, a pin 203b of the driving section 201b extends to a position of a depth db of the image forming medium P. As described above, by making the depth at which the pin 203 hits the image forming medium P different between the driving section 201a and the driving section 201b, a depth of recessed portion of the image forming medium P is also different between the driving section 201a and the driving section 201b. Therefore, by separately using different kinds of the driving sections 201 for forming different depths on the image forming medium P, the image forming medium P can be recessed in various depths. Needless to say, in the image forming medium P in which the concave portions are formed, a portion that is deeply recessed is highly raised when seen from the surface on the opposite side. The pin 203 of the driving section 201a is referred to as the pin 203a. The pin 203 of the driving section 201b is referred to as the pin 203b.

The processing apparatus 200 including two types of the driving sections 201 composed of the driving section 201a and the driving section 201b can perform the unevenness processing at three stages of heights including a height when the pin 203a of the driving section 201a is struck against the image forming medium P, a height when the pin 203b of the driving section 201b is struck against the image forming medium P, and a height when neither of the pins 203 is struck against the image forming medium P. The stage of the height at which the processing apparatus 200 can perform processing is hereinafter referred to as a “processing enabled stage”.

The processing apparatus 200-2 in which the number of the processing enabled stages is three is described above. The processing apparatus 200-2 may be provided with a driving section 201c, a driving section 201d, . . . in addition to the driving section 201a and the driving section 201b, and in this case, it is possible to set the number of the processing enabled stages to four or more. In this case, as an example, the depths at which the pins 203 hit the image forming medium P are in a relationship of the driving section 201a<the driving section 201b<the driving section 201c<the driving section 201d< . . . .

Through the above, the processing apparatus 200 is an example of an unleveling section which forms at least either concave portions or convex portions on the image forming medium P.

Next, the circuit configuration of the main portions of the image forming apparatus 100 is described with reference to FIG. 7. FIG. 7 is a block diagram illustrating an example of a circuit configuration of main portions of the image forming apparatus 100.

As shown in FIG. 7, the image forming apparatus 100 includes a processor 121, a ROM (Read-Only Memory) 122, a RAM (Random-Access Memory) 123, an auxiliary storage device 124, a communication interface 125, a printing section 126, an operation panel 116 and the processing apparatus 200. These components are connected with each other through a bus 127 or the like.

The processor 121 acts as a central part of a computer for performing a processing such as an arithmetic processing, a control processing or the like necessary for the operation of the image forming apparatus 100. The processor 121 controls each section to realize various functions of the image forming apparatus 100 based on programs such as system software, application software or firmware stored in the ROM 122 or the auxiliary storage device 124. The processor 121 is, for example, a CPU (Central Processing Unit), a MPU (Micro Processing Unit), a SoC (System on a Chip), a DSP (Digital Signal Processor), a GPU (Graphics Processing Unit), an ASIC (Application Specific Integrated Circuit), a PLD (Programmable Logic Device), a FPGA (Field-Programmable Gate Array) or the like. Alternatively, the processor 121 is a combination of several ones among the above components.

The ROM 122 acts as a main storage device of the computer with the processor 121 as the central part. The ROM 122 is a non-volatile memory exclusively used for reading data. The ROM 122 stores the above programs. The ROM 122 stores data used for the processor 121 to execute various processing or various setting values.

The RAM 123 acts as a main storage device of the computer with the processor 121 as the central part. The RAM 123 is a memory used for reading and writing data. The RAM 123 is used as a so-called working area for storing data temporarily used for the processor 121 to execute various processing.

The auxiliary storage device 124 acts as an auxiliary storage device of the computer with the processor 121 as the central part. The auxiliary storage device 124 is, for example, an EEPROM (Electric Erasable Programmable Read-Only Memory), a HDD (Hard Disk Drive), a SSD (Solid State Drive), or the like. The auxiliary storage device 124 stores the above programs in some cases. The auxiliary storage device 124 stores the data used by the processor 121 to execute various processing, data generated by the processing by the processor 121, various setting values, and the like. The image forming apparatus 100 may have an interface into which a storage medium such as a memory card or a USB (Universal Serial Bus) can be inserted in place of or in addition to the auxiliary storage device 124.

The programs stored in the ROM 122 or the auxiliary storage device 124 include a program for executing a processing described later. As an example, the image forming apparatus 100 is transferred to an administrator of the image forming apparatus 100 with the program stored in the ROM 122 or the auxiliary storage device 124. However, the image forming apparatus 100 may be transferred to the administrator in a state in which the program is not stored in the ROM 122 or the auxiliary storage device 124. The image forming apparatus 100 may be transferred to the administrator with a program different from the program stored in the ROM 122 or the auxiliary storage device 124. The program for executing the processing described later may be separately transferred to the administrator and written into the ROM 122 or the auxiliary storage device 124 under the operation of the administrator or a service person. The transfer of the program at this time can be realized by recording the program in a removable storage medium such as a magnetic disk, a magneto-optical disk, an optical disk, a semiconductor memory or the like, or downloading the program via a network.

The communication interface 125 is used by the image forming apparatus 100 to perform communication via the network or the like.

The printing section 126 performs operations relating to printing under the control of the processor 121. The printing section 126 includes, for example, the sheet feed roller 103, the toner cartridge 104, the image forming section 105, the transfer belt 106, the transfer roller 107 and the fixing section 108.

The bus 127 includes a control bus, an address bus, a data bus, and the like, and transmits a signal transmitted and received between respective sections of the image forming apparatus 100.

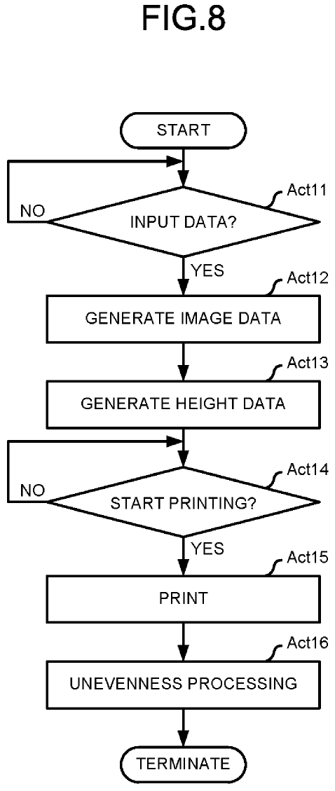

Below, the operation of the image forming apparatus 100 according to at least one embodiment is described with reference to FIG. 8 to FIG. 10. The contents of the processing in the following description of the operation are merely an example, and various processing capable of achieving the same result can be suitably used. FIG. 8 to FIG. 10 are flowcharts depicting a processing by the processor 121 of the image forming apparatus 100. The processor 121 executes the processing by executing the program stored in the ROM 122 or the auxiliary storage device 124. When the processor 121 proceeds to the processing in Act (N+1) (N is a natural number) after the processing in Act N, the description for explaining that may be omitted.

In Act 11, the processor 121 stands by until data necessary for embossed printing is input. Here, the data necessary for the embossed printing is capable of generating print image data for use in printing and height data for use in the unevenness processing. The data is input to the communication interface 125, for example. Alternatively, the data is input from the auxiliary storage device 124. Alternatively, the data is input from another processing. If the data necessary for the embossed printing is input, the processor 121 determines Yes in Act 11 and proceeds to the processing in Act 12.

In Act 12, the processor 121 generates the print image data for use in the printing from the data input in Act 11. The print image data, for example, indicates a color component corresponding to coordinates (x, y). The color components are indicated by, for example, CMYK or CMY. Here, C, M, Y or K indicates concentration when the printing is performed by using cyan recording material, magenta recording material, yellow recording material or black recording material, respectively. If the color information included in the data input in Act 11 is indicated by RGB, the processor 121 converts it into CMYK or CMY. The coordinates (x, y) used in the print image data indicate, for example, a position on the image forming medium P which is a printing object.

In Act 13, the processor 121 generates height data for use in the unevenness processing from the data input in Act 11. The height data is, for example, data indicating the height (z) for individual coordinates (x, y). In the height data, it is necessary that the stage of the height is at or below the processing enabled stage. Therefore, the processor 121 resamples the height data as required so that the stage of the height is at or below the processing enabled stage. Thus, for example, if the number of the processing enabled stages is four, the height of each coordinate included in the height data is any one of 0, 1, 2, and 3. The coordinates (x, y) used in the height data indicate, for example, a position on the image forming medium P where a concave portion or a convex portion is to be formed. The coordinate system in the print image data and the coordinate system in the height data may be the same or different. However, the two coordinate systems can be mutually converted.

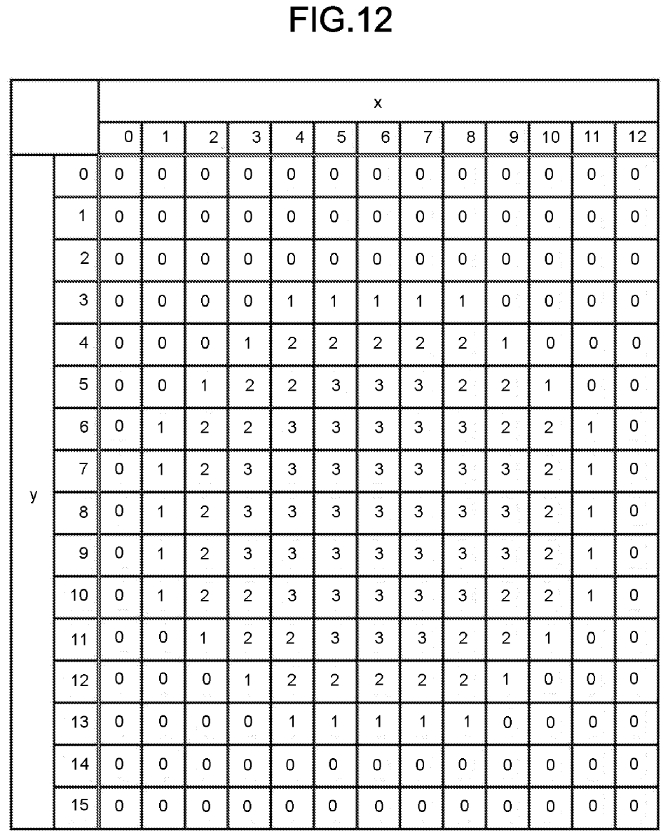

For example, if a three-dimensional object as shown in FIG. 11 is converted to height data of four stages, data as shown in FIG. 12 is obtained. FIG. 11 is a two-side view illustrating an example of the three-dimensional object. The two-side view includes a side view G1 and a top view G2. Further, FIG. 12 is a diagram illustrating an example of the height data.

In Act 14, the processor 121 stands by until an operation for instructing the start of the printing. The operator of the image forming apparatus 100 issues an instruction to start the printing. If the operation for instructing the start of the printing is performed, the processor 121 determines Yes in Act 14 and proceeds to the processing in Act 15.

In Act 15, the processor 121 controls the printing section 126 to perform printing on the image forming medium P based on the print image data generated in Act 12.

In Act 16, the processor 121 inputs the height data to the processing apparatus 200. If the processing apparatus 200 is the processing apparatus 200B, the processor 121 conveys the image forming medium P after printing to convey it into the processing apparatus 200B. In Act 16, the processor 121 controls the processing apparatus 200 to perform the unevenness processing on the image forming medium P on which the printing is performed in Act 15 based on the height data generated in Act 13. For example, if the number of the processing enabled stages is two, through such a control, the driving section 201 strikes the pin 203 against the image forming medium P when a coordinate at which the height of the image forming medium P is 1 passes. When the number of the processing enabled stages is three or more, through such a control, the driving section 201a strikes the pin 203 against the image forming medium P when the coordinate at which the height of the image forming medium P is 1 passes. Then, through such a control, the driving section 201b strikes the pin 203 against the image forming medium P when the coordinate at which the height of the image forming medium P is 2 passes. Through such a control, the driving section 201c, the driving section 201d, . . . , also strike the pin 203 against the image forming medium P when the coordinate at which the height of the image forming medium P is 3, 4 . . . passes. Through the processing in Act 16, the unevenness based on the height data is formed in the image forming medium P.

After the processing in Act 16, the processor 121 terminates the processing shown in FIG. 8.

Next, the data necessary for the embossed printing, which is input in Act 11, is described.

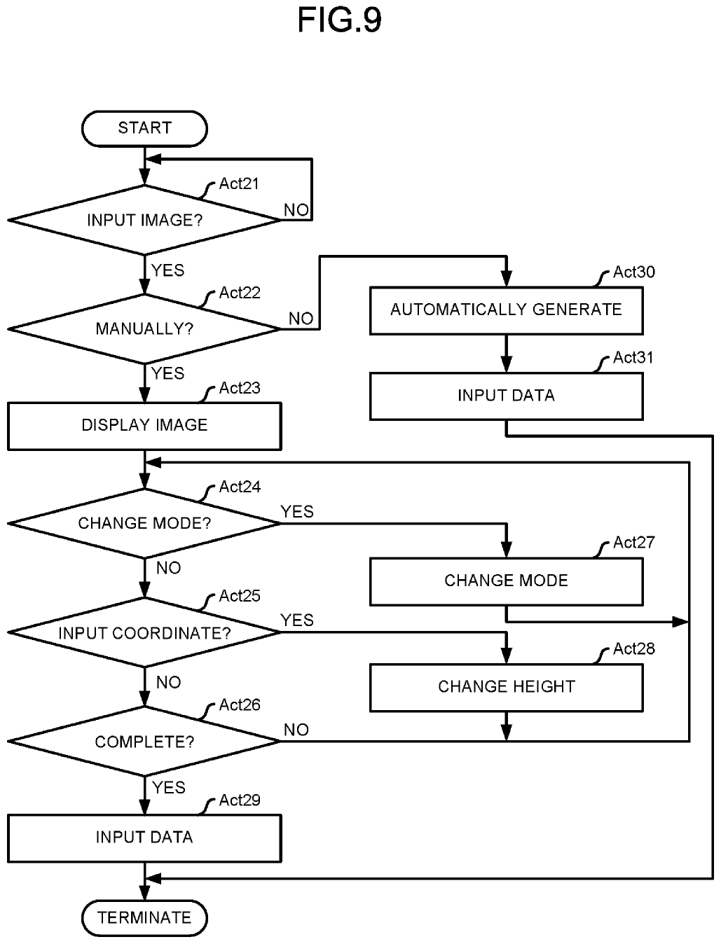

An example of a method for creating the data necessary for the embossed printing is described with reference to FIG. 9.

In Act 21, the processor 121 stands by until an image is input. The image is input, for example, by being read by the scanning section 114. Alternatively, the image may be input by being received by the communication interface 125. The image received by the communication interface 125 is transmitted from, for example, a PC (Personal Computer) or a server. If the image is input, the processor 121 determines Yes in Act 21 and proceeds to the processing in Act 22.

In Act 22, the processor 121 determines whether to manually designate the height. The height can be designated manually and automatically. Whether the height is manually designated or automatically designated is determined based on an operation by the operator of the image forming apparatus 100 or the like, for example. If it is determined that the height is manually designated, the processor 121 determines Yes in Act 22 and proceeds to the processing in Act 23.

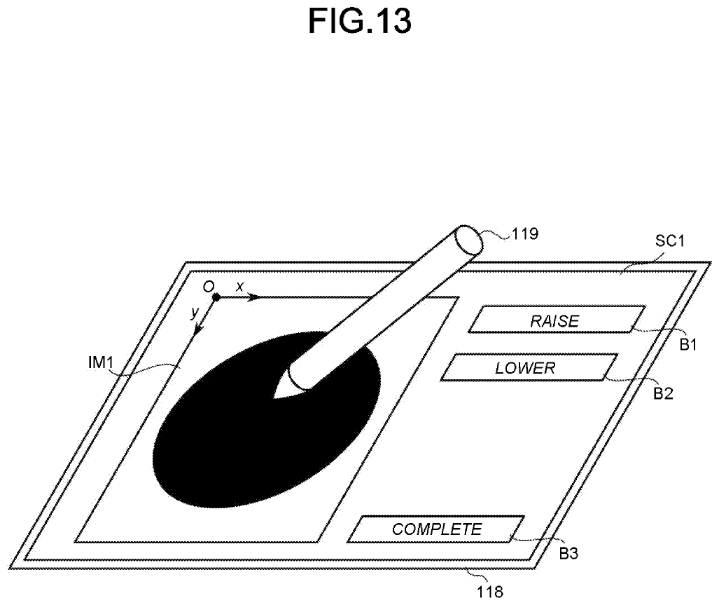

In Act 23, the processor 121 displays the image input in Act 21 on the display device 118. For example, the processor 121 displays a screen SC1 as shown in FIG. 13. FIG. 13 is a diagram illustrating a method of designating the unevenness of an image. The screen SC1 includes an image IM1, a raising button B1, a lowering button B2, and a completion button B3. The image IM1 is the image input in Act 21. The raising button B1 is operated when an edit mode is set to a raising mode. The lowering button B2 is operated when the edit mode is set to a lowering mode. The completion button B3 is operated when the designation of the height is completed.

Accordingly, the display device 118 is an example of a display section (display) for displaying an image.

In Act 24, the processor 121 determines whether or not an operation for changing the edit mode is performed. If the operation for changing the edit mode is not performed, the processor 121 determines No in Act 24 and proceeds to the processing in Act 25.

In Act 25, the processor 121 determines whether or not there is an input for designating coordinates on the image. If there is no input for designating the coordinates on the image, the processor 121 determines No in Act 25 and proceeds to the processing in Act 26.

In Act 26, the processor 121 determines whether or not an operation for completing the designation of the height is performed. If the operation for completing the designation of the height is not performed, the processor 121 determines No in Act 26 and returns to the processing in Act 24. Thus, the processor 121 repeats the processing in Act 24 to Act 26 until the operation for changing the edit mode is performed, there is the input for designating coordinates on the image, or the operation for completing the designation of the height is performed.

For example, when the raising button B1 or the lowering button B2 is operated, the processor 121 determines that the operation for changing the edit mode is performed.

If it is determined that the operation for changing the edit mode is performed in the standby state in Act 24 to Act 26, the processor 121 determines Yes in Act 24 and proceeds to the processing in Act 27.

In Act 27, the processor 121 changes the edit mode in response to the content of the operation for changing the edit mode. For example, when the raising button B1 is operated, the processor 121 changes the edit mode to the raising mode. For example, when the lowering button B2 is operated, the processor 121 changes the edit mode to the lowering mode. When the edit mode before change and the edit mode after change are the same, the processor 121 does not need to change the edit mode. The edit mode is not limited to the raising mode and the lowering mode, and may be other modes. After the processing in Act 27, the processor 121 returns to the processing in Act 24.

When the display device 118 is a liquid crystal pen tablet, the operator of the image forming apparatus 100 touches the image IM1 displayed on the display device 118 with a touch pen 119 as shown in FIG. 13, for example. Alternatively, if the display device 118 is a touch panel, the operator touches the image IM1 displayed on the display device 118 with his/her finger or the like. The operator touches a portion, of which the height is desired to be changed, in the image IM1 displayed on the display device 118. When there is a portion (the height of which is desired to be increased) desired to be raised in the image IM1, the operator touches the portion desired to be raised in the image IM1 while the edit mode is the raising mode. If there is a portion desired to be lowered in the image IM1, the operator touches the portion desired to be lowered in the image IM1 while the edit mode is the lowering mode.

The processor 121 determines that there is an input for designating the coordinates on the image when the image IM1 is touched with the touch pen 119 or a finger. If there is an input for designating the coordinates on the image in the standby state in Act 24 to Act 26, the processor 121 determines Yes in Act 25 and proceeds to the processing in Act 28.

In Act 28, the processor 121 changes the height indicated by height data for edit according to the input coordinates and the edit mode. The height data for edit is generated on the RAM 122 by the processor 121, for example. The height data for edit indicates the height of each coordinate on the image IM1.

If the edit mode is the raising mode, the processor 121 raises the height of the input coordinate with respect to the height data for edit. The processor 121 may also raise the height of the coordinate around the input coordinate with respect to the height data for edit as required. When the height is a predetermined upper limit, the processor 121 does not raise the height any more.

When the edit mode is the lowering mode, the processor 121 lowers the height of the input coordinate with respect to the height data for edit. The processor 121 may lower the height of the coordinate around the input coordinate with respect to the height data for edit as required. If the height is a predetermined lower limit, the processor 121 does not lower the height any more.

When the display device 118 is the liquid crystal pen tablet, the processor 121 may increase a change amount of the height as the writing pressure when touched with the touch pen 119 becomes strong. The processor 121 may increase the change amount of the height as the time taken to touch the display device 118 with the touch pen 119 becomes long.

When the display device 118 is the touch panel, the processor 121 may increase the change amount of the height as a touch force on the display device 118 becomes strong. The processor 121 may increase the change amount of the height as the time taken to touch the display device 118 becomes long.

Through the above, the processor 121 cooperates with the display device 118 to operate as a designation section for designating the coordinate on the image displayed on the display device 118.

After the processing in Act 28, the processor 121 returns to the processing in Act 24.

If the operation for completing the designation of the height is performed in the standby state in Act 24 to Act 26, the processor 121 determines Yes in Act 26 and proceeds to the processing in Act 29.

In Act 29, the processor 121 inputs the image input in Act 21 and the height data for edit into the processing shown in FIG. 8. After the processing in Act 29, the processor 121 terminates the processing shown in FIG. 9. With this input, the processor 121 determines Yes in Act 11 in FIG. 8 and proceeds to the processing in Act 12.

Then, in Act 12, the processor 121 generates image data based on the image input in Act 21. Further, in Act 13, the processor 121 generates height data based on the height data for edit.

As described above, the processor 121 operates as a first generation section (first generator) that generates image data. The processor 121 operates as a second generation section (second generator) that generates height data based on the coordinates designated by the designation section.

On the other hand, if the processor 121 determines to automatically designate the height, the processor 121 determines No in Act 22 and proceeds to the processing in Act 30.

In Act 30, the processor 121 automatically designates the height based on the image input in Act 21. For example, based on the image, the processor 121 generates the height data in which the height is higher for the coordinate where a value of luminance, brightness or saturation is larger. Alternatively, the processor 121 may generate height data in which the height is higher for a coordinate where a value of luminance, brightness or saturation is smaller. Alternatively, the processor 121 may generate height data in which the height is higher for a coordinate where density of a specific color is higher or thinner. The processor 121 may generate the height data based on each color component using other methods. The processor 121 may detect an outline from the image and increase or decrease the height of the coordinate of the outline.

In Act 31, the processor 121 inputs the image input in Act 21 and the height data generated in Act 30 to the processing shown in FIG. 8. After the processing in Act 31, the processor 121 terminates the processing shown in FIG. 9. According to the input, the processor 121 determines Yes in Act 11 in FIG. 8 and proceeds to the processing in Act 12. Then, in Act 12, the processor 121 generates image data based on the image input in Act 21. Furthermore, in Act 13, the processor 121 uses the height data generated in Act 30 without any change. Alternatively, the processor 121 may convert the height data for use in the unevenness processing.

As described above, the processor 121 operates as an acquisition section that acquires the image by executing the processing in Act 21.

Other examples (1) to (4) of the data necessary for the embossed printing and a method for generating the print image data and the height data in each example are described. The data may be in a dedicated data format or an existing data format.

(1) Combination of image and monochrome image

The processor 121 generates the print image data based on the image.

A monochrome image includes a channel of only one color. For example, the processor 121 generates the height data when it is assumed that the height is higher for a portion where the density of the color is higher. Alternatively, the processor 121 may generate the height data when it is assumed that the height is higher for a portion where the density of the color is thinner.

(2) An image including a channel in addition to the channels indicating color information used for printing

The image includes channels such as RGB or CMYK as color information used for printing. Furthermore, the image includes another channel. As another channel, an alpha channel mainly indicating opacity or a spot color channel indicating density of a special color may be provided.

The processor 121 generates the print image data based on the color information.

The processor 121 generates the height data based on another channel. For example, the processor 121 generates the height data when it is assumed that the height is higher as a numerical value of another channel is larger.

(3) Data including the color information and the height information

The processor 121 generates the print image data based on the color information included in the data. The processor 121 generates the height data based on the height information included in the data.

(4) 3D (three-dimensional) data Based on the 3D data, the processor 121 generates the print image data and the height data as follows, for example.

For example, the processor 121 generates the print image data based on an image obtained by viewing a 3D object generated from the 3D data at infinity in a specific direction.

For example, the processor 121 generates the height data of the 3D object generated based on the 3D data in which a distance between a reference plane and a portion that is visible when viewing the 3D object at infinity in the specific direction. The reference plane is perpendicular to the specific direction.

The specific direction is designated, for example, through an operation by the operator of the image forming apparatus 100 or the like. Alternatively, the specific direction may be automatically determined by the processor 121. The reference plane is designated, for example, through an operation by the operator of the image forming apparatus 100 or the like. Alternatively, the reference plane may be automatically determined by the processor 121.

The 3D data may be input from a 3D scanner after the 3D scanner scans the 3D object. The image forming apparatus 100 may be connectable to the 3D scanner. Alternatively, the image forming apparatus 100 may include the 3D scanner.

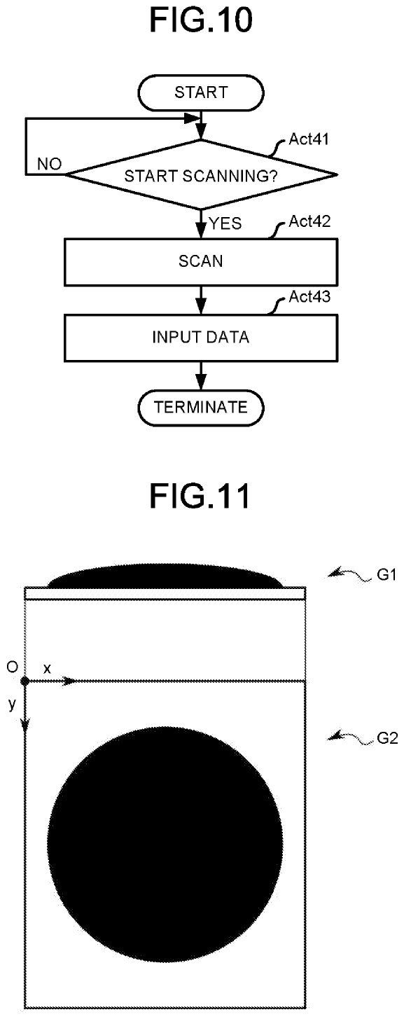

Next, the unevenness copying function is described with reference to FIG. 10.

When the operator of the image forming apparatus 100 wants to use the unevenness copying function, by operating the operation panel 116, an operation for instructing the start of unevenness copying is performed. In response to the operation, the processor 121 starts the processing shown in the flowchart in FIG. 10.

for instructing the start of scanning is performed.

The operator of the image forming apparatus 100 places an object to be subjected to the unevenness copying on a scanning table such as a glass table on the scanning section 114. Then, the operator of the image forming apparatus 100 performs an operation for instructing the start of scanning.

If the operation for instructing the start of scanning is performed, the processor 121 determines Yes in Act 41 and proceeds to the processing in Act 42.

In Act 42, the processor 121 controls the scanning section 114 to read the image and the unevenness from the object.

In Act 43, the processor 121 inputs the image data and unevenness data read in Act 42 to the processing shown in FIG. 8. After the processing in Act 43, the processor 121 terminates the processing shown in FIG. 10. According to the input, the processor 121 determines Yes in Act 11 in FIG. 8 and proceeds to the processing in Act 12.

Then, in Act 12, the processor 121 generates the image data based on the input image data. Further, in Act 13, the processor 121 generates the height data based on the unevenness data.

Through the above, the processor 121 is an example of a generation section (generator) that generates the print image data and the height data.

The image forming apparatus 100 of at least one embodiment can form the unevenness on the sheet without preparing a mold or the like. For this reason, the image forming apparatus 100 of the embodiment can reduce labor and cost as compared with the conventional image forming apparatus. Furthermore, since the image forming medium P used in the image forming apparatus 100 of at least one embodiment may be a conventionally used sheet or the like, the cost can be lowered as compared with a case of using a dedicated sheet or the like.

The image forming apparatus 100 of at least one embodiment performs printing and forms the unevenness on the image forming medium P. Therefore, according to the image forming apparatus 100 of at least one embodiment, a three-dimensional image can be formed on the image forming medium P by aligning the printing position and the position of the unevenness.

The image forming apparatus 100 of at least one embodiment including the processing apparatus 200-2 comprises a plurality of types of the driving sections 201 in which the depths at which the pins 203 hits are different. As a result, the image forming apparatus 100 can perform the unevenness processing at three or more stages of heights. If the processing enabled stage is high, the image forming apparatus 100 enables high-expressive unevenness processing.

The image forming apparatus 100 of at least one embodiment generates the image data and the height data based on the 3D data. As a result, the image forming apparatus 100 of the embodiment can perform the embossed printing based on the 3D data.

The image forming apparatus 100 of at least one embodiment performs the unevenness processing on the image forming medium P after printing.

A toner image is transferred from the transfer belt 106 onto the image forming medium P in the secondary transfer. At this time, when the unevenness processing is performed on the image forming medium P, there is a case in which the toner on the transfer belt 106 is not in sufficient contact with the image forming medium P. In this case, the transfer performance is lowered.

The fixing of the secondarily transferred image on the image forming medium P is performed by the fixing section 108. In a fixing step, the image forming medium P is heated and pressurized. However, when the unevenness processing is performed on the image forming medium. P, there is a possibility that there is a portion to which the heating and pressurization are not properly applied.

In the image forming apparatus 100 of at least one embodiment, the problem described above does not occur by performing the unevenness processing after printing.

In the image forming apparatus 100 of at least one embodiment, by reading the image and the unevenness from the object, it is possible to perform unevenness copying reproducing the unevenness and the color of the object.

In the image forming apparatus 100B of at least one embodiment, the processing apparatus 200B is externally attached. Therefore, it is possible to form the unevenness by connecting the processing apparatus 200B to the existing image forming apparatus. Alternatively, it is possible to form unevenness without making any significant change to the design of the existing image forming apparatus.

The above embodiments can also be modified as follows.

In some of the above embodiments, the depths at which the pins 203 hit the image forming medium P satisfy the relationship: the driving section 201a<the driving section 201b<the driving section 201c<the driving section 201d< . . . . However, the relationship of the magnitude of the depth at which the pin 203 hits the image forming medium P is not limited thereto. For example, the depths at which the pins 203 hit the image forming medium P may satisfy a relationship: the driving section 201a>the driving section 201b>the driving section 201c>the driving section 201d> . . . .

In at least one embodiment, the printing in the embossed printing is color printing. However, the printing in the embossed printing may be monochrome printing. The printing in the embossed printing may be performed using a decolorable recording material.

In some of the above embodiments, the image forming apparatus 100 strikes the pin 203 against the back surface of the image forming medium P. However, the image forming apparatus 100 may strike the pin 203 against the front surface (printed surface) of the image forming medium P. By doing in this way, the image forming apparatus 100 can perform a processing in which the printed image is recessed. In other words, concave portions are formed on the image forming medium P against which the pin 203 is struck from the front surface side as seen from the printed surface side.

In some of the above embodiments, the image forming apparatus 100 strikes the pin 203 against one surface of the image forming medium P. However, the image forming apparatus 100 may strike the pin 203 against both surfaces of the image forming medium P. For example, the image forming apparatus 100 inverts the front and back surfaces of the image forming medium P in which one surface is struck by the pin 203 with the duplex sheet feed unit 113. Then, the image forming apparatus 100 strikes the pin 203 against the image forming medium P, of which the front and back surfaces are reversed. Although the duplex sheet feed unit 113 is used for duplex printing, the duplex sheet feed unit 113 is also used for striking the pin against both surfaces, thereby reducing the cost compared with a case of using a dedicated mechanism for striking the pin against both surfaces. Alternatively, the image forming apparatus 100 may include the driving section 201 which strikes the pin 203 against the surface of the image forming medium P, and a driving section which strikes the pin 203 to the back surface of the image forming medium P. In this case, since reversing operation using the duplex sheet feed unit 113 is unnecessary, the unevenness processing can be performed at a higher speed when compared with a case in which the reversing operation is performed.

As described above, by striking the pin 203 against both surfaces of the image forming medium P, the image forming apparatus 100 forms the unevenness, which cannot be expressed by merely striking the pin 203 against one surface of the image forming medium P, on the image forming medium P.

In the above embodiment, each driving section 201 has a fixed stroke length. However, the processing apparatus 200 may include a driving section 201 in which the stroke length is variable. In this case, even if the processing apparatus 200 does not have a plurality of types of the driving sections 201 in which the depths at which the pins 203 hit the image forming medium P are different, it is possible to perform the unevenness processing at three or more stages of heights.

In some of the above embodiments, the force for striking the pin 203 against the image forming medium P is fixed in each driving section 201. However, the image forming apparatus 100 may have a driving section 201 in which the force for striking the pin 203 against the image forming medium P can be variable. In this case, in the image forming apparatus 100, it is possible to perform the unevenness processing at more stages of heights by changing the force for striking the pin 203 against the image forming medium P.

In some of the above embodiments, the pin 203 hits one location of the image forming medium P once in the image forming apparatus 100. However, in the image forming apparatus 100, the pin 203 may hit the image forming medium P a plurality of times for one location.

Depending on the type of the sheet, at least one of the force for striking the pin 203 against the image forming medium P, the stroke length, and the number of times the pin 203 is struck against one location may be changed. The type of the sheet is designated through an operation by a user. Alternatively, the image forming apparatus 100 may discriminate the type of sheet using a sensor capable of discriminating the type of sheet. By doing in this way, the image forming apparatus 100 can perform the unevenness processing at the same height regardless of the type of the sheet. Depending on the type of the sheet, the image forming apparatus 100 can prevent the sheet from being broken by weakening the strike or pressing force or shortening the stroke length.

In some of the above embodiments, in the processing apparatus 200, the driving sections 201 corresponding to the maximum width of the sheet are aligned. However, the processing apparatus 200 may include a head that is movable in the left and right direction and has fewer driving sections 201. The processing apparatus 200 then strikes or presses the image forming medium P while moving the head. By doing in this way, it is possible to reduce the number of the driving sections 201, thereby reducing the cost and reducing the weight of the apparatus. If the driving sections 201 corresponding to the maximum width of the sheet are aligned as in the above embodiment, the unevenness processing can be performed at a higher speed when compared with a case of moving the driving sections 201 left and right.

In some of the above embodiments, the image forming apparatus 100 performs the printing by a dry electrophotographic system (laser printer). However, the image forming apparatus 100 may perform the printing by other printing systems such as an inkjet system or a thermal transfer system.

The image forming apparatus 100B may be directly connected to the processing apparatus 200 without the relay unit 117.

In some of the above embodiments, the image forming apparatus 100 performs the printing on the image forming medium P and then performs the unevenness processing. However, the image forming apparatus may perform the printing on the image forming medium P after performing the unevenness processing.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a printing section configured to form an image on a medium based on image data indicating a color component corresponding to a coordinate indicating a position on the medium; and
an unleveling section, which has a protrusion capable of abutting against the medium, configured to format least either a convex portion or a concave portion on the medium by enabling the protrusion to abut against or move away from the medium on which the printing section forms an image, the convex or concave portion formed based on height data indicating a height of each coordinate indicating the position on the medium.

2. The image forming apparatus according to claim 1, wherein
the unleveling section includes a plurality of types of protrusions with different strokes, the unleveling section configured to form at least either concave portions or convex portions having different heights on the medium with the protrusions having respective different strokes based on height indicated by the height data.

3. The image forming apparatus of claim 1, wherein
the unleveling section includes a plurality of types of protrusions having different lengths, and the unleveling section configured to form at least either concave portions or convex portions having different heights on the medium with the protrusions having respective different lengths based on height indicated by the height data.

4. The image forming apparatus according to claim 1, wherein
the unleveling section includes an elastic plate at a position facing the protrusion across a conveyance path of the medium.

5. The image forming apparatus according to claim 4, wherein
the unleveling section includes an actuator configured to drive the protrusion into the medium and elastic plate.

6. The image forming apparatus according to claim 1, further comprising:
a generator configured to acquire an image, to generate the image data based on the image, and to generate the height data based on the image.

7. The image forming apparatus according to claim 6, wherein the generator is configured to generate the height data based on a density of a specific color of regions of the image.

8. The image forming apparatus according to claim 6, wherein the generator is configured to generate the height data based on a luminance, brightness or saturation of regions of the image.

9. The image forming apparatus according to claim 6, wherein the generator is configured to generate the height data to be higher when a luminance, brightness or saturation of regions of the image is higher.

10. The image forming apparatus according to claim 1, further comprising:
a generator configured to generate the image data based on 3D data and generate the height data based on the 3D data.

11. The image forming apparatus according to claim 1, wherein
the unleveling section is configured to form concave portions and convex portions on the medium by enabling the protrusion to abut against or move away from both surfaces of the medium.

12. The image forming apparatus according to claim 1, further comprising:
an acquisition section configured to acquire an image;
a first generator configured to generate the image data based on the image;
a display configured to display the image;
a designation section configured to designate a coordinate on the image displayed on the display; and
a second generator configured to generate the height data based on the coordinate designated by the designation section.

13. The image forming apparatus according to claim 12, where the display includes a pen tablet and the designation section includes a touch pen.

14. The image forming apparatus according to claim 1, further comprising:
a reader configured to read an image and unevenness from an object; and
a generator configured to generate the height data based on the unevenness and to generate the image data based on the image read.

15. The image forming apparatus according to claim 1, further comprising:
a printing device comprising the printing section; and
a processing apparatus comprising the unleveling section and connected to the printing device, wherein
the printing device is configured to input height data to the processing apparatus and to convey the medium printed by the printing section into the processing apparatus.

16. A method of forming an image, comprising:
forming an image on a sheet-like medium based on image data indicating a color component corresponding to a coordinate indicating a position on the medium; and
forming, via a protrusion, at least either a convex portion or a concave portion on the medium by enabling the protrusion to abut against or move away from the medium, the convex or concave portion formed based on height data indicating a height of each coordinate indicating the position on the medium.

17. The method according to claim 16, further comprising forming at least either concave portions or convex portions having different heights on the medium with protrusions having respective different strokes based on height indicated by the height data.

18. The method of claim 16, further comprising
forming at least either concave portions or convex portions having different heights on the medium with protrusions having respective different lengths based on height indicated by the height data.

19. The method according to claim 16, further comprising:
acquiring an image and generating the image data based on the acquired image to generate the height data based on the image.

20. The method according to claim 16, further comprising:
generating the image data based on 3D data and generating the height data based on the 3D data.
